(19) United States
(12) Patent Application Publication
(10) Pub. No.: US 2002/0128842 A1
(43) Pub. Date: Sep. 12, 2002

(54) Method of automatic payment of a software license fee

(76) Inventors: Dieter Hoi, Guntramsdorf (AT); Harald Romsdorfer, Vienna (AT)

Correspondence Address: Corporate Patent Counsel, U.S. Philips Corporation, 580 White Plains Road, Tarrytown, NY, 10591, US

(21) Appl. No.: 10/082,935

(22) Filed: Oct. 22, 2001

(30) Foreign Application Priority Data
Oct. 23, 2000 (EP) 00890319.7

(51) Int. Cl. G10L 13/08

(52) U.S. Cl. 704/260

(57) ABSTRACT

To realize a per-use business model for paying software license fees for a service program run by a service arrangement (1, 32) connected to the Internet (NET), the service arrangement includes software license fee payment means (15) which at moments of payment send software license payment information (LAI) to a pay system (18) connected to the Internet (NET). The pay system (18) receives software license payment information (LAI) from many service arrangements (1, 32) connected to the Internet (NET) and makes out bills for the software license fees to be paid by the operators of the service arrangements (1, 32), which bills cover the payment intervals.

The invention relates to a method of paying a software license fee for a service program which is run by a service arrangement in which the service arrangement renders a service available to user devices.

The invention further relates to a transcription service arrangement for providing a transcription service and for paying a software license fee for a speech recognition program run by the transcription service arrangement.

The invention further relates to a pay system for automatically paying a software license fee for a service program run by a service arrangement.

The invention further relates to a computer program product which may be loaded directly into the internal memory of a digital computer and comprises software code sections.

Such a transcription service arrangement of the type defined above in the second paragraph is known from document GB 2 323 693 A. The known transcription service arrangement is formed by a server and enables a transcription service to transcribe speech information of a user's dictation with one from a plurality of speech recognition programs.

The known server receives an audio file by e-mail or telephone, which audio file contains speech information of a dictation by an author of the dictation. The server then checks whether the author is a registered user of this transcription service and whether an account number of the user is known for the payment for the transcription service. When the user and his account number are known, the server processes the received speech information with a speech recognition program run by the server. The server then runs a plurality of speech recognition programs for simultaneously transcribing a plurality of dictations.

The text information recognized from the user's speech information by the speech recognition program is subsequently checked by an employee of the transcription service for visible recognition errors and edited where appropriate. The server then determines service abort information which is determined from the number of words in the recognized text information and the amount of time for the employee of the transcription service. Then the corrected text information is sent to the user of the transcription service —for example, by e-mail—and the user's account is charged with the cost for the transcription service corresponding to the service payment information.

With the known transcription service it has turned out to be disadvantageous for the operator of the transcription service arrangement to pay software license fees to the manufacturer of the speech recognition program for the speech recognition programs to be run in future by the transcription service arrangement, before the transcription service can even be operated for the first time. These software license fees are charged to someone's account in advance either for each speech recognition program run in parallel by the transcription service arrangement, or for each registered user of the transcription service, and represent relatively high initial cost for the operator of the transcription service.

It is an object of the invention to provide a computer-related business method in which the initial cost of software license fees of a service program for an operator of a new service arrangement is relatively low and is paid to the manufacturer of the service program in line with the actual use of the service program. To achieve this object, a method of automatic payment of a software license fee provides characteristic features according to the invention, so that the method may be characterized in the manner described hereinafter.

A method of automatic payment of a software license fee for a service program which is run by a service arrangement, in which the service arrangement executes the following steps of the method:

receiving input information from a user device of a user of the service offered by the service arrangement;

processing the received input information with the service program and rendering output information available;

determining service payment information for the processing of the input information of the user device with the service program;

sending the available output information and, as the case may be, also the determined service payment information to the user device;

determining software license payment information from at least one of the determined service payment information signals;

sending the determined software license payment information to a pay system for automatic payment of the software license fee for the service program, which pay system provides a bill for the software license fee for the use of the service program by the operator of the service arrangement, which bill is based on the received software license payment information.

To achieve this object, a transcription service arrangement has characteristic features according to the invention for automatic payment of a software license fee, so that the transcription service arrangement may be characterized in the manner defined hereinafter.

A transcription service arrangement for offering a transcription service and for determining software license payment information, to enable an automatic payment of a software license fee for a speech recognition program run by the transcription service arrangement, comprising receiving means for receiving speech information of a dictation from a user device of a user of the transcription service, and comprising speech recognition means which, when the speech recognition program is run, is provided for processing the received speech information and for providing text information which is recognized from the received speech information, and comprising service payment means for determining service payment information for the transcription of the user's speech information, and comprising service send means for sending the recognized text information and, as the case may be, also the service payment information to the user device, and comprising software license payment means for determining the software license payment information from at least one of the determined service payment information signals, and comprising software license send means for sending the determined software license payment information to a pay system which is provided for preparing a bill for the software license fee on the basis of the received software license payment information for the use of the speech recognition program by the operator of the transcription service arrangement.

To achieve this object, a pay system for automatic payment of a software license fee has characteristic features according to the invention, so that the pay system may be characterized in the manner defined hereinafter.

A pay system for automatic payment of a software license fee for a service program run by a service arrangement, comprising receiving means for receiving software license payment information from the service arrangement, which runs the service program so that input information is processed by a user device and output information is delivered to the user device, and comprising software license billing means for processing the received software license payment information and for preparing a bill for the software license fee for the use of the service program by the operator of the service arrangement.

A computer program product which can be directly loaded into the internal memory of a digital computer and comprises software code sections, in which the steps of the method as claimed in claim 1 are executed with a computer when the product runs on the computer.

This advantageously achieves that the operator of a new service arrangement has to pay no or only little initial cost for the software license fees to the manufacturer of the service program for each actual use of the service programs when the service is actually used by users. It is then particularly advantageous that the service payment information, determined for paying for the service rendered to the respective users of the service, is directly collected by the service arrangement to determine the software license payment information for the software license fee and is automatically sent to a pay system.

According to the measures as claimed in claim 2 a transcription service is obtained with which the user of the transcription service needs to pay software license fees to the manufacturer of the speech recognition program only per transcribed dictation.

According to the measures as claimed in claim 3, the advantage is obtained that the identification number of the service program identifies the service arrangement that runs the service program, which identification number is contained in the software license payment information and in the software license payment information sent to the pay system. With this identification number the pay system can make up the address of the bill and kind of payment for the software license fee bill from a user database of the pay system.

According to the measures as claimed in claim 4, the advantage is obtained that the coded software license payment information is protected from manipulations to lower the software license fee.

According to the measures as claimed in claim 5 the advantage is obtained that only a single software license payment information signal needs to be transferred to the pay system even if the service arrangement runs the service program a number of times in parallel.

According to the measures as claimed in claim 7 the advantage is obtained that a manipulation of the service payment information or of the software license payment information by the transcription service arrangement is detected and appropriate steps can be initiated to avoid this manipulation.

According to the measures as claimed in claims 8 and 10 the advantage is obtained that the software license fee can also be paid based on a prepaid business model which is known, for example, from the payment of telephone charges for mobile telephones.

According to the measures as claimed in claim 9 the advantage is obtained that the pay system periodically obtains (for example, on a daily or monthly basis) software license payment information from each service arrangement to find out the functioning of the payment of the software license fee. It is then highly advantageous that even then software license payment information is transferred to the pay system and thus the functioning of the payment of the software license fee is realized when the service arrangement has not run the service program in the period of the payment.

The aspects defined above and further aspects of the invention are apparent from and will be elucidated with reference to the examples of embodiments described hereinafter to which, however, the invention is not restricted.

In the drawings:

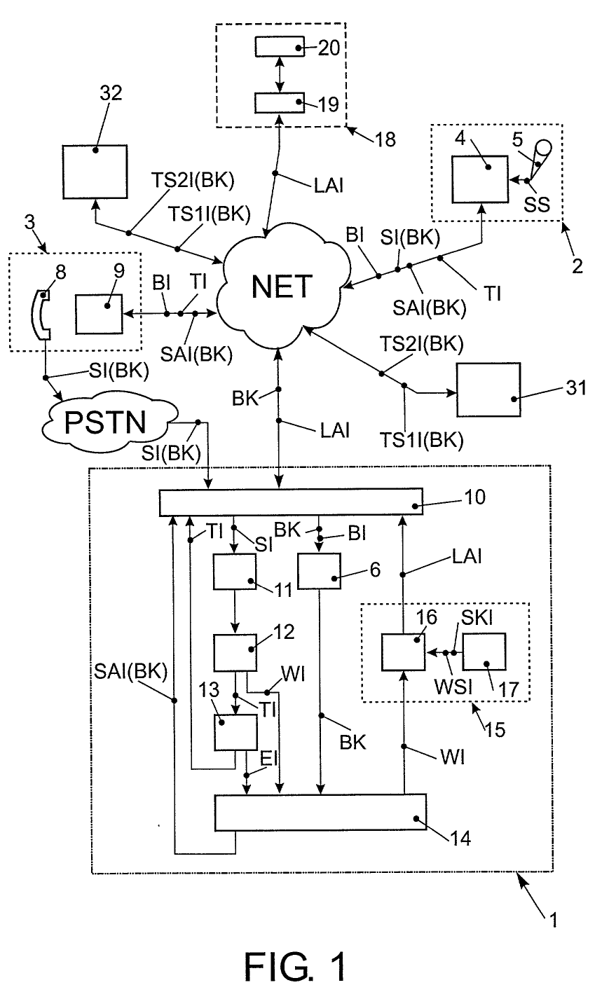

FIG. 1 shows a transcription service arrangement for offering a transcription service and for determining software license payment information for a pay system to enable an automatic payment of a software license fee for a speech recognition program run by the transcription service arrangement,

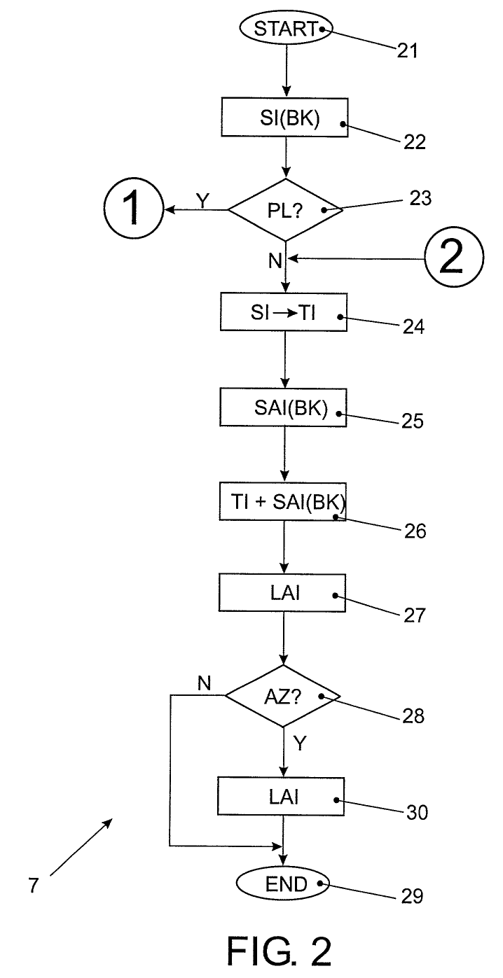

FIG. 2 shows a flow chart which is implemented by the transcription service arrangement shown in FIG. 1 and which enables a per-use business model to pay the software license fee for the speech recognition program, and

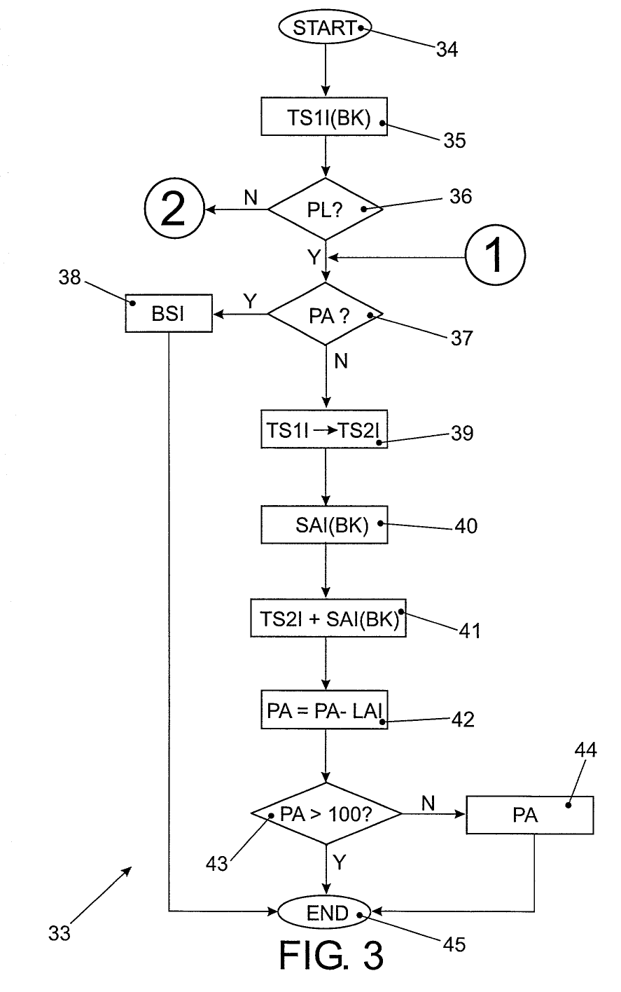

FIG. 3 shows a flow chart which is utilized by the transcription service arrangement shown in FIG. 1 and which enables a payment of the software license fees in accordance with the per-use business model and, additionally, based on a prepaid business model.

FIG. 1 shows a transcription service arrangement formed by a server 1 for offering a transcription service and determining software license payment information to enable an automatic payment of software license fee for a speech recognition program run by the transcription service arrangement. FIG. 1 further shows a first user device 2 and a second user device 3 which are both connected to the server 1 via the Internet NET and by which the transcription service offered by the server 1 can be utilized.

The first user device 2 is formed by a computer 4 to which a microphone 5 is connected. A user of the computer 4 may speak a text or a dictation, respectively, into the microphone 5 after which a speech signal SS is delivered to the computer 4. The speech signal SS is then processed by the computer 4 and stored on a hard disk of the computer 4 as digital speech information SI.

If the user of the computer 4 likes to utilize the transcription service of the server 1, the user is to call an Internet browser software program (for example, the Internet explorer by Microsoft) run by the computer 4 and enter the Internet address of the server 1. Subsequently, he is to go through a log-on procedure with the server 1, in which the user's name, his e-mail address and the desired type of payment for the transcription service to be utilized in the future, is to be disclosed. All this user information BI together with a user identification BK determined by the server 1 is stored in user identification means 6 of the server 1 and the user identification BK is made known to the user for each further log-on to the transcription service of the server 1 via an acknowledge e-mail.

After the log-on procedure has been successfully terminated, the user can send the stored speech information SI to the server 1 as an attachment to an e-mail, together with the user's identification BK. The server 1 processes this information SI and BK in accordance with a flow chart 7 shown in FIG. 2, which will be further discussed hereinafter.

The server 1 sends recognized text information TI assigned to the received speech information SI by the server 1 after the received speech information SI has been processed successfully, which text information TI is sent together with service payment information SAI(BK) to the first user device 2 as an e-mail. This text information TI is then displayed on a monitor of the computer 4 and the user is to pay the amount indicated in the service payment information SAI(BK) for the transcription service used according to the type of payment agreed upon.

The second user device 3 is formed by a telephone 8 and a computer 9. After the successful termination of the log-on procedure of the second user device 3, the user of the second user device 3 can dial the telephone number of the server 1 and set up a telephone link to the server 1 over the public telephone network PSTN. Subsequently, the user can enter his user identification BK with the keys of the telephone 8 and speak a text or dictation, respectively, into the telephone 8. The respective speech information SI is then transmitted to the server 1 together with the user identification BK of the second user device 3 via the public telephone network PSTN.

The information SI and BK received by the server 1 from the second user device 3 is also processed in accordance with the flow chart 7. The recognized text information TI assigned to the speech information SI by the server 1, and the service payment information SAI(BK) determined by the server 1, is sent to the computer 9 as an e-mail and displayed by a monitor of the computer 9.

The manner described above provides an interesting transcription service for authors who use one of the user devices 2 or 3. Such a transcription service is used, for example, by physicians in a hospital for dictating findings and medical histories, and is also known from document GB 2 323 693 A, whose publication is to be regarded as hereby incorporated by reference.

The server 1 is formed by a powerful computer which is capable of running computer programs which comprise a plurality of software code sections in parallel. The server 1 has an interface 10 which forms receiving means for receiving the speech information SI(BK) from one of the user devices 2 or 3 of a user who has logged on to the transcription service. The interface 10 further forms service transmission means for transmitting the text information TI recognized by the server 1 and for transmitting the service payment information SAI(BK) determined by the server 1 to the respective user device 2 or 3. For communication with the user devices 2 and 3 over the Internet NET, the interface 10 is provided for executing a TCP/IP protocol and for running an e-mail software program—such as, for example, Lotus Notes by IBM. To enable a communication with the telephone 8 over the public telephone network PSTN, the interface 10 includes telephone interface means which have been known for a long time.

To enable the transcription service, the server 1 further includes audio processing means 11, speech recognition means 12, editing means 13 and service payment means 14. The received digital speech information SI is preprocessed by the audio processing means 11 for a subsequent speech recognition process. This preprocessing includes, on the one hand, the correction of transmission fields of the received speech information SI and, on the other hand, a decoding of the possibly coded digital speech information SI.

The speech recognition means 12 are formed by a speech recognition program run by the server 1 for the use of which program the user of the server 1 is to pay software license fee to the maker of the speech recognition program. The speech recognition program is provided for processing the received preprocessed speech information SI and for providing text information TI recognized from the received preprocessed speech information SI. Such a speech recognition program has been known for a long time and has been marketed since 1995 as “SpeechMagic”, for example, by the applicants, so that this will not be further discussed here.

The speech recognition means 12 deliver, on the one hand, the recognized text information TI to the editing means 13 as a result of the speech recognition operation, and deliver word information WI to the service payment means 14. The word information WI then indicates the number of words contained in the recognized text information TI and is used by the service payment means 14 for determining the service payment information SAI(BK).

The editing means 13 are formed by a text processing program run by the server 1—such as, for example, the program “Word for Windows” by Microsoft. An employee of the transcription service edits with the editing means 13 obvious mistakes in the text information TI recognized by the speech recognition means 12. The amount of work for this employee of the transcription service depends, on the one hand, on how well the author has dictated the text (uniform speed during dictation, clear stressing of the words, . . . ) and, on the other hand, on how good the recognition rate of the speech recognition software was during the recognition of the text information TI.

The editing means 13 transfer the edited text information TI to the interface 10 after the editing of the recognized text information TI has ended, and delivers editing information El to the service payment means 14. The editing information El then features the number of editing operations carried out by the employee of the transcription service on the edited text information TI. Editing operations are here deletions, replacements, insertions and similar further customary possibilities of editing a text.

The service payment means 14 of the server 1 are arranged for determining the service payment information SAI(BK) for the transcription of the user's speech information SI via the user identification BK. For this purpose, the service payment means 14 multiply the number of words featured by the word information WI in the recognized text information TI by a multiplier “0.01”. Furthermore, the number of editing operations featured by the editing information El is multiplied by a multiplier “0.05” and the multiplication results thus obtained are added together to obtain the service payment information SAI(BK) in dollars ($). The service payment information SAI(BK) determined in this manner is charged to the user for the use of the transcription service and transmitted for this purpose to the user's device 2 or 3 via the interface 10.

The server 1 includes software license payment means 15 which are arranged for determining software license payment information from at least one of the service payment information signals SAI(BK) determined by the service payment means 14. For this purpose, the software license payment means 15 include an payment stage 16 and a memory stage 17.

When the speech recognition software is installed on the server 1, the operator of the server 1 is asked according to what business model he likes to pay the software license fee. The operator may then choose between the business model of paying a lump sum once for the software license fee or make a per-use payment of the software license fee in accordance with the per-use business model. In addition, the operator can also select a prepaid business model which will be further discussed hereinafter with reference to a flow chart in FIG. 3.

When the maker of the speech recognition software has received operator information of the server 1 (account number, standing order, . . . ), which enable to pay the software license fee per use, the manufacturer of the speech recognition software renders a per-use license key available to the operator of the server 1 and stores this operator information together with service identification information SKI which identifies the operator of the server 1. With the per-use license key, the operator of the server 1 can install the speech recognition software in accordance with the per-use business model. In this case an enciphered software module is installed on the server 1 when the speech recognition software is installed, which enciphered software module forms the software license payment means 15.

After service payment information SAI(BK) has been determined, the service payment means 14 deliver the word information WI received from the speech recognition means 12 to the payment stage 16 as part of the service payment information SAI(BK). The payment stage 16 adds the number of transcribed words of the just transcribed dictation featured by the word information WI to word sum information WSI stored in the memory stage 17. The word sum information WSI thus features the number of all the words transcribed by the speech recognition program since the installation of the speech recognition program. The word sum information WSI is stored enciphered in the storage space 17 to avoid manipulations.

The payment stage 16 further includes a timer which causes the payment stage 16 to send the software license payment information LAI every 30 days to a pay system 18 connected to the Internet NET. The Internet address and the e-mail address of the pay system 18 are stored in the memory stage 17 of the software license payment means 15. The software license payment information LAI transferred to the pay system 18 contains not only the word sum information WSI read from the memory stage 17 but also the service information SKI, which features the operator of the server 1 and enables the operator to pay the software license fee. The software license payment information LAI is transferred in encoded form to avoid manipulation.

The pay system 18 is operated on behalf of the manufacturer of the speech recognition program and on behalf of the manufacturer of other service programs. The pay system 18 contains receiving means 19 and software license payment means 20. The pay system 18 is arranged for receiving the software license payment information LAI from the server 1 via the receiving means 19.

The software license payment means 20 are arranged for deciphering the received enciphered software license payment information LAI and for determining the amount of the bill in dollars ($) which the operator of the server 1 is to pay to the manufacturer of the speech recognition program for the use of the speech recognition program. For this purpose, the software license payment means 20 subtract the word sum information WSI received by the server 1 30 days previously from the just received word sum information WSI and multiply the result of the subtraction by a multiplier “0.002”, as a result of which the amount of the bill in dollars ($) is obtained. The bill is sent to the address of the operator of the server 1, which address is stored in the received service identification information in the software license payment means 20.

If the operator of the server 1 has chosen the per-use business model, the advantage is obtained that the operator of the server 1 needs to pay no or only little initial cost for the software license fee for the speech recognition program, because the software license fee is to be paid for each actual use of the speech recognition program, just like when the transcription service is actually used by users. It is then particularly advantageous that the service payment information SAI(BK) determined for paying for the individual transcription services to the respective users of the service, or information already determined for determining the service payment information SAI(BK), is collected directly for determining the software license payment information LAI for the software license fee by the server 1 and automatically sent to the pay system 18. This leads to practically no additional computation circuitry in the server 1.

The software license payment means 16 and the software license payment means 20 now additionally check whether the transmitted word sum information WSI is plausible or whether it was manipulated. For this purpose, the increase of the word sum information WSI is observed over a plurality of months and irregularities then found are automatically passed on to the operator of the pay system 18.

This offers the advantage that the operator of the pay system 18 can take further steps of testing the word sum information WSI at the server 1, to get the payment of the justified software license fee through.

The software license payment means 16 are also arranged for periodically (every 30 days) sending the software license payment information LAI to the pay system 18 when the speech recognition program was not run by the server 1 in the period of payment (within the last 30 days). This offers the advantage that the functioning of the server 1 with respect to determining the software license payment information LAI and the functioning of the transmission over the Internet NET can be ascertained every 30 days. Manipulations of the software license payment means 15—by deleting or inactivating the software module forming the software license payment means 15—may thus be automatically detected by the pay system 18.

In the following is explained in more detail the method of automatic payment of the software license fee for the speech recognition program by the server 1 with reference to the flow chart 7 in FIG. 2 and with reference to a concrete example of embodiment. It is assumed that the user of the second user device 3 has called the server 1 by telephone 8 and has entered his user identification BK. Then the processing of the flow chart 7 is started at a block 21.

The speech information SI(BK) of the dictation dictated into the telephone 8 by the user is received by the interface 10 in a block 22. In a block 23 the software license payment means 15 verify whether the prepaid business model for paying the software license fee was selected during the installation of the speech recognition program. If this is the case, the path \mathring{1} in the flow chart according to FIG. 3 is branched off. Similarly, the branching-off is made from the flow chart shown in FIG. 3 according to path \mathring{2} to the flow chart 7 when the prepaid business model was not selected.

Since the prepaid business model was not selected during the installation of the speech recognition program, the processing of the flow chart is continued with a block 24. In block 24 the speech recognition program is run by the server 1 and the text information TI having 500 words is recognized for the received speech information SI of the dictation. This recognized text information TI is applied to the editing means 13 and the word information WI=“500” to the service payment means 14. During the editing of the recognized text information TI, 10 editing processes are carried out, after which the edited information TI is applied to the interface 10 and the editing information EI=“10“is applied to the service payment means 14.

In block 25 the service payment means 14 then calculate the service payment information SAI(BK)=“500*0.01+10*0.05=5.5$” which the user of the second user device 3 is to pay to the operator of the server 1 for the use of the transcription service.

In block 26 the text information TI recognized from the user's dictation and edited and also the determined service payment information SAI(BK) is sent as e-mail to the computer 9 of the second user device 3 by the interface 10.

In block 27 the service payment means 14 deliver the word information WI=“500” to the payment stage 16 and the word sum information WSI=“37,232” of all the words recognized thus far by the speech recognition program are read from the memory stage 17 by the payment stage 16. The payment stage 16 adds the word information WI to the word sum information WSI and stores the word sum information WSI=“37,732” in the memory stage 17 as a result.

In block 28 a test is made whether the payment instant AZ (every 30 days) has already been reached. If the software license payment information LAI was sent to the pay system 18 for the last time less than 30 days earlier, the flow chart 7 is terminated with a block 29. If, on the other hand, the payment instant AZ has already been reached, the word sum information WSI=“37,732” is read from the memory stage 17 in a block 30 and sent to the pay system 18 as an e-mail together with the service identification information of the server 1 and the flow chart 7 is terminated with a block 29. The block 27 is also executed by the software license payment means 15 when the timer of the payment stage 16 establishes that the payment instant AZ has been reached.

The software license payment means 20 subtract the word sum information WSI=“22,234” received 30 days previously from the now received word sum information WSI=“37,732” on reception of the software license payment information AZ and multiply the result by the multiplier “0.002” to determine the software license fee of 31$ for the past 30 days. This software license fee is debited to the account of the user of the server 1.

The above method of automatic payment of the software license fee for the speech recognition program has the advantage that the software license fee is continuously paid and need not be paid at one time when the speech recognition program is bought. It is extremely advantageous when the server 1 runs several speech recognition programs in parallel. In that case a plurality of speech information signals SI of a plurality of dictations can be processed in parallel and the software license payment means 15 can transfer the software license payment information LAI for all these speech recognition programs to the pay system 18 together.

In FIG. 1 is further shown a third user device which is formed by a computer 31. The third user device was logged on during a log-on procedure with a translation service system 32 shown in FIG. 1, which renders a translation service available. The structure of the translation service arrangement 32 corresponds to the structure of the server 1 shown in FIG. 1, whereas, however, a translation program is run instead of the speech recognition program, for which translation program the operator of the translation service arrangement 32 is to pay software license fee to the manufacturer of the translation program. Furthermore, text processing means are provided in lieu of the audio processing means.

When the translation program is installed, the operator of the translation service arrangement 32 has decided in favor of the per-use business model combined with the prepaid business model. With the prepaid business model the operator of the translation service system 32 need not disclose any information for paying the software license fee in the pay system 18, but he can buy a prepaid balance PA from the manufacturer of the translation program in the pay system 18. The periodically liable software license fees are then booked to the debit of the prepaid balance PA, as this is explained with reference to the following example of embodiment and to a flow chart 33 in FIG. 3.

According to the example of application it is assumed that the user of the computer 31 would like to have a French text formed by first text speech information TS1I(BK) translated by the translation service arrangement 32 into a Chinese text formed by second text speech information TS2I(BK). To this end the user has logged on to the translation service arrangement 32 to which he sends the first text speech information TS1I together with the user identification BK of the computer 31 as an e-mail to the translation service arrangement 32.

When an e-mail is received, the translation service arrangement 32 starts executing the flow chart 33 with a block 34, after which, in a block 35, the first text speech information TS1I(BK) is received. In a block 36 the software license payment means of the translation service arrangement 32 check whether the prepaid business model was selected at the installation of the translation program. If the prepaid business model was not selected at the installation of the translation program, a change is made to the flow chart 7 shown in FIG. 2 in accordance with the path 02 which flow chart 7 is also executed by the translation service arrangement 32 for other users that have not chosen the prepaid business model.

In a block 37 the text processing means determine the number of words to be translated in the first text speech information TSI(BK) and check whether the prepaid balance PA stored in the memory stage is sufficiently large. If the prepaid balance PA is not sufficiently large for the determined number of words to be translated, an e-mail is sent to the computer 31 by the interface in a block 38, which e-mail contains the information that the translation service arrangement 32 is out of operation.

If, on the other hand, the prepaid balance PA is sufficiently large, the translation service arrangement 32 is allowed to execute the translation program. In block 39 the first text speech information TS1I(BK) is translated into the second text speech information TS2I(BK) by the translation program. Such translation programs have been known for a long time, so that they will not be further discussed here.

In block 40 service payment information SAI(BK) is determined for the translation service from the number of translated words and from the editing operations carried out by an employee of the translation service. In block 41 the determined service payment information SAI(BK) and the second text speech information TS2I(BK) is sent to the computer 31.

In block 42 the software license fee determined from the number of translated words is deducted from the prepaid balance PA stored in the memory stage and the reduced prepaid balance PA is again stored in the memory stage.

In block 43 a test is made whether the prepaid balance PA stored in the memory stage of the software license payment means exceeds “100” units with which the software license fee can still just be paid for an application of the translation program for a text with a very large number of words to be translated. When the prepaid balance PA< “100” units, the interface sends to a block 44 an e-mail to the pay system 18 to order a further prepaid balance with PA=“10.000” units. If, on the other hand, the prepaid balance PA>“100” units, the flow chart 33 is terminated at a block 45.

The pay system 18 is arranged for supporting the prepaid business model so that, on reception of an e-mail for ordering a further prepaid balance PA, an enciphered software module is sent to the sender of the e-mail when the e-mail contains a valid credit card number to pay the prepaid balance PA. If the operator of the translation service arrangement 32 has received the encoded software module by e-mail, he has to have the encoded software module executed by the translation service arrangement 32 to store the further prepaid balance PA in the memory stage.

It may be observed that the pay system 18 could also render the automatic payment of software license fees available for the text processing program executed by the server 1. At the same time the software license fees for the manufacturer of the text processing program could also be determined automatically in accordance with the per-use business model.

It may be observed that the software license payment information LAI may be determined in various ways. For example, the software license payment information LAI for the text processing program could be determined based on the editing information.

It may be observed that the software license payment information LAI can also be determined directly from the service payment information SAI(BK) and not—as discussed in the example above—from information (word information WI) for determining the service payment information SAI(BK). In that case the service payment information SAI(BK) instead of the word sum information WSI in the software license payment information LAI could be transmitted to the pay system. The service payment information SAI(BK) may also be formed by the word information WI and then the user is to execute the multiplication of the word information WI by the multiplier autonomously, which is compatible with the transcription service arrangement for determining the amount of the bill in dollars ($).

It may be observed that the software license payment information LAI can also be transmitted to the pay system on a daily or annual base. Similarly, the software license payment information LAI can be transmitted when, for example, a certain number of words have been transcribed (after each 10,000 transcribed words) since the last transmission of the software license payment information LAI. In that case the pay system could directly charge the respective amount of the software license fee without further calculations.

The service program according to the invention, including the software module forming the software license payment means, may be stored not only on a data carrier —such as, for example, a CD-ROM—but also downloaded as a signal from a server over data lines.

It may be observed that the software license payment means may transmit additional information encoded in the software license payment information LAI, which additional information enables the pay system to detect a manipulation of the word sum information in the memory stage. As a result, irregularities can be detected and steps for future avoidance of these manipulations can be initiated.

1. A method of automatic payment of a software license fee for a service program which is run by a service arrangement, in which the service arrangement executes the following steps of the method:
receiving input information from a user device of a user of the service offered by the service arrangement;
processing the received input information with the service program and rendering output information available;
determining service payment information for the processing of the input information of the user device with the service program;
sending the available output information and, as the case may be, also the determined service payment information to the user device;
determining software license settlement information from at least one of the determined service payment information signals;
sending the determined software license payment information to a pay system for automatic payment of the software license fee for the service program, which pay system provides a bill for the software license fee for the use of the service program by the operator of the service arrangement, which bill is based on the received software license payment information.

2. A method as claimed in claim 1, in which the service arrangement runs a speech recognition program and in which the service arrangement receives speech information of a dictation of a user as input information and processes same with the speech recognition program and in which text information of the dictation recognized from the received speech information by the speech recognition program is sent as output information to the user device of the user of the service arrangement.

3. A method as claimed in claim 1, in which an identification number of the service program is entered in the software license payment information during the installation of the software of the service program and is stored by the service arrangement.

4. A method as claimed in claim 1, in which the software license payment information is stored in encoded form by the service arrangement.

5. A method as claimed in claim 1, in which the service arrangement executes at least two service programs in parallel and in which the service arrangement takes these at least two service programs into account when the software license payment information is determined.

6. A transcription service arrangement for offering a transcription service and for determining software license payment information, to enable an automatic payment of a software license fee for a speech recognition program run by the transcription service arrangement, comprising receiving means for receiving speech information of a dictation from a user device of a user of the transcription service, and comprising speech recognition means which, when the speech recognition program is run, are arranged for processing the received speech information and for providing text information which is recognized from the received speech information, and comprising service payment means for determining service payment information for the transcription of the user's speech information, and comprising service send means for sending the recognized text information and, as the case may be, also the service payment information to the user device, and comprising software license payment means for determining the software license payment information from at least one of the determined service payment information signals, and comprising software license send means for sending the determined software license payment information to a pay system which is provided for preparing a bill for the software license fee on the basis of the received software license payment information for the use of the speech recognition program by the operator of the transcription service arrangement.

7. A transcription service arrangement as claimed in claim 6, in which the software license payment means are arranged for detecting a manipulation of determined service payment information and for detecting a manipulation of the determined software license payment information.

8. A transcription service arrangement as claimed in claim 6, in which the software license payment means are arranged for requesting a new prepaid balance from the pay system when the prepaid balance stored in the pay system has nearly been used up.

9. A transcription service arrangement as claimed in claim 6, in which the software license send means are provided for periodically sending the determined software license payment information to the pay system even when the speech recognition program was not run in the payment interval by the transcription service arrangement.

10. A pay system for automatic payment of a software license fee for a service program run by a service arrangement, comprising receiving means for receiving software license payment information from the service arrangement, which runs the service program so that input information is processed by a user device, and output information is delivered to the user device, and comprising software license billing means for processing the received software license payment information and for preparing a bill for the software license fee for the use of the service program by the operator of the service arrangement.

11. A pay system as claimed in claim 10, in which the software license billing means are provided for deducting the amount of the available bill from a prepaid balance of the operator of the service arrangement.

12. A computer program product which can be directly loaded into the internal memory of a digital computer and comprises software code sections, in which the computer executes the steps of the method as claimed in claim 1 when the product runs on the computer.

13. A computer program product as claimed in claim 12, in which it is stored on a medium that can be read by a computer.
